(19) United States
(12) Patent Application Publication
(10) Pub. No.: US 2006/0004652 A1
(43) Pub. Date: Jan. 5, 2006

(54) Loan option algorithm adaptable to fully variable option loans and fixed option loans

(76) Inventors: Russell H. Greig JR., Norcross, GA (US); Robert A. Greig, Potomac, MD (US)

Correspondence Address: David P. Kelley, 3822 Courtyard Drive, Atlanta, GA, 30339-5948, US

(21) Appl. No.: 11/158,490

(22) Filed: Jun. 22, 2005

Related U.S. Application Data
(60) Provisional application No. 60/582,030, filed on Jun. 22, 2004.

(51) Int. Cl. G06F 17/60

(52) U.S. Cl. 705/38

(57) ABSTRACT

A system and program or method embodiment in a computer readable medium for monitoring a loan option program wherein the borrower has one of several options for omitting without penalty one or more installment payments, either on a fixed schedule or on a variable schedule. The basic method comprises a determination of the loan parameters without options; determining the type of loan option and revising the loan parameters in accordance therewith, determining interest change, if any, after an omitted payment; determining balance change after omitted payment; determining change in term of loan, if any, after omitted payment; and recalculating new payment schedule under changed parameters.

This invention relates to a loan option algorithm which is adaptable to fully variable option loans and fixed option loans, which is disclosed in the U.S. provisional application serial number 60,582,030, filed Jun. 22, 2004.

### FIELD OF THE INVENTION

### SUMMARY OF THE INVENTION

Loan Options is the process where a lender gives an option to the borrower to omit one or more payments between the first and last payment. The Option and parameters of the loan are negotiated at origination.

Within Loan Options, there are unlimited combinations of the key parameters: schedule of omitted payment, term and interest rate.

### SCHEDULE OF OMITTED PAYMENTS

It can be predetermined when the borrower will omit the first payment, but only after making the first “n” payments. The borrower can decide to omit one payment every twelve months, one every six months, one every three months or one every other month. Alternatively, the borrower can be given the full choice of when to exercise the option on the first payment, and subsequent omitted payments, subject to making a minimum number of payments between any two omitted payments.

Term

In addition, the term of the loan can be increased for each omitted payment, or the term can remain fixed, but then the amount of each remaining payment is increased.

Interest Rate

The interest rate can remain fixed at the rate for a loan without Loan Options. Alternatively, the interest rate can be increased at the time of each option exercise (or just at the first) by a fixed amount. The interest rate can also float, capped or uncapped until option exercise. Interest does continue to accrue on the outstanding balance, such that payment after omitted payment has more than one month's (regular payments) interest.
Next is a short algorithm of the process:
Determine loan parameters and payments of standard loan without Loan Options,
Offer Loan Options to borrower,
If borrower accepts Loan Options, determine parameters
Determine if borrower wants full option to choose omitted payments or determine loan omission schedule at origination,
Determine if interest will change or remain fixed per loan without Loan Options,
Determine if term will increase or remain fixed,
Detail payment schedule given parameters or detail formula for recalculating payment if borrower takes full option to choose omitted payment.

The algorithm is preferably embodied in a computer program for use in a suitable computer or central processing unit capable of reading and acting out the steps of the program.

### BRIEF DESCRIPTION OF THE DRAWINGS

FIG. 1 is a flow chart for a fully variable option loan;

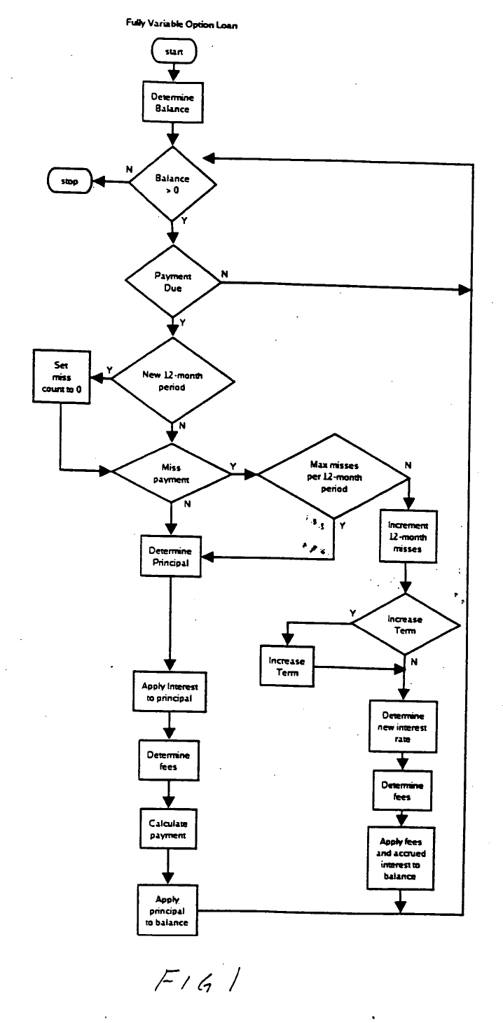

FIG. 2 is a flow chart for a fixed option loan; and

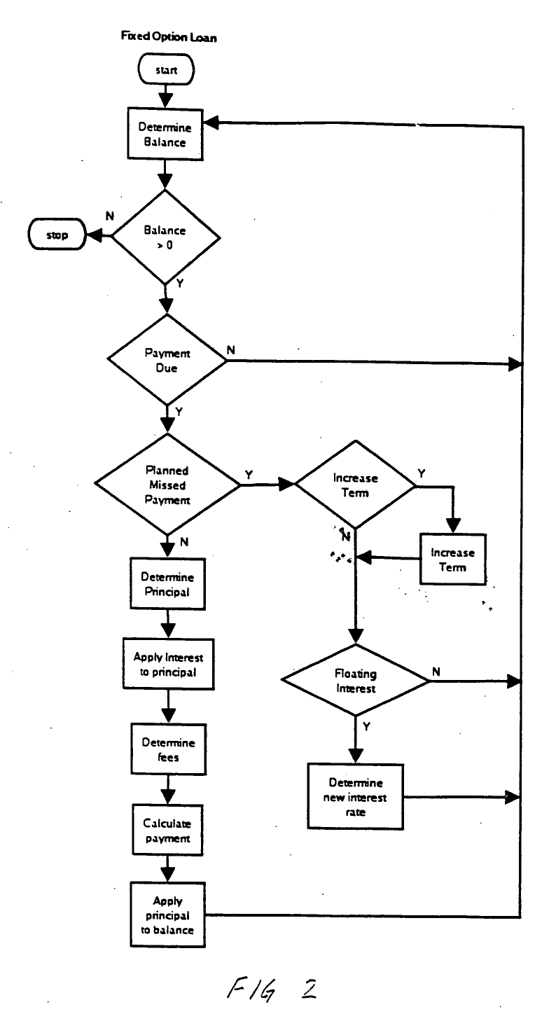

FIG. 3 is a combined flow chart for a standard loan, fully variable option loan, and a fixed option loan.

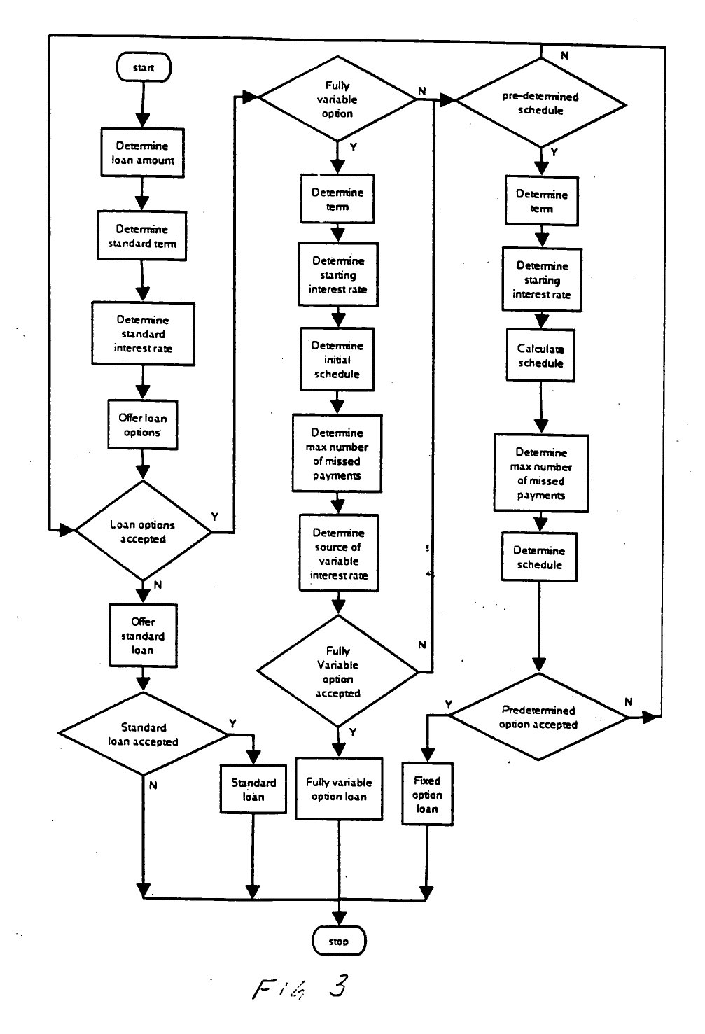

Therefore, having thus described the invention, at least the following is claims:

1. A loan option program that directs a processing unit to perform the following steps:
determining the amount of the loan;
establishing an incremental payment schedule;
re-determining the principal amount of the loan due following a permissible missed payment;
establishing a new interest rate after increasing the new term of the loan; and
calculating a new incremental payment.

2. A loan options program as claimed in claim 1, wherein the number of permissible missed payments in a twelve month period is monitored, and the term of the loan is increased after each missed payment.

3. A loan option program as claimed in claim 1, wherein the term of the loan remains fixed and the incremented payment account is increased.
